(19) United States
(12) Patent Application Publication
(10) Pub. No.: US 2015/0334006 A1
(43) Pub. Date: Nov. 19, 2015

(54) METHOD TO DO FAST TRAFFIC SWITCHOVER BASED ON SERVER LAYER STATUS

(71) Applicant: Mingchao Shao, Rockville, MD (US)

(72) Inventor: Mingchao Shao, Rockville, MD (US)

(73) Assignee: TELEFONAKTIEBOLAGET L M ERICSSON (PUBL), Stockholm (SE)

(21) Appl. No.: 14/395,593

(22) PCT Filed: Apr. 20, 2012
(86) PCT No.: PCT/CN2012/074416

§ 371 Date: Oct. 20, 2014

(51) Int. Cl. H04L 12/707; H04L 12/723; H04L 12/26; H04L 12/703

(52) U.S. Cl. CPC H04L 45/22; H04L 45/28; H04L 45/50; H04L 43/0817

(57) ABSTRACT

A method and apparatus perform fast traffic switchover based on server layer status. To do fast traffic switchover when there is server layer failure, each forwarding entry in a forwarding table contains an index to server layer status table, wherein traffic is associated to a service layer based on the physical communication resources used by the primary path. The server layer status table contains status code for all instances of server layers in the system. One status code indicates the server layer status is normal, and primary paths may be used to carry client layer traffic. Another status code indicates abnormal condition on the server layer, and that primary paths cannot be used to carry client layer traffic. When the forwarding entry is used to forward incoming packets, the server layer status code is checked. If the status code indicates normal functionality, the failover object is checked to route the traffic on either the primary or secondary path. If the status code indicates the server layer is non-functional, the forwarding entry corresponding to the secondary path is used to forward incoming packets. When a failure is detected, or a known failure is cured, the server layer status table is updated.

### TECHNICAL FIELD

The present invention relates generally to communication networks, and in particular to a system and method of efficiently switching traffic based on server layer.

### BACKGROUND

Communication networks are well known and widely deployed. A variety of protocols and technologies have been developed to route data through communication networks, as well as perform “overhead” functions relating to maintenance and management of the network itself. The latter are known in the art generally as Operations, Administration, and Maintenance or Management (OAM) functions.

One example of a communication network data routing protocol is Multiprotocol Label Switching (MPLS), which directs data from node to node within a network based on short path labels rather than long network addresses (e.g., IP addresses), avoiding the need for look-ups into routing tables at each node. MPLS prefixes packets with an MPLS header, which contains one or more labels (known as a label stack). A Label Switched Path (LSP) is a path through an MPLS network defined by a set of labels assigned by each node in the path. An LSP begins at an ingress Label Edge Router (LER), proceed along a plurality of Label Switched Routers (LSR), and terminates at an egress LER. The ingress LER prefixes a label to a data packet, and passes it along to an LSR, which swaps the packet's outer label for another label, and forwards it to the next LSR. The egress LER pops the MPLS label from the packet, and forwards the packet toward a destination based on another protocol (e.g., IPv4 addressing). An LSP is unidirectional, and may include protection against link or node failure (known as linear protection) by provisioning both a primary, or protected LSP, and a secondary, or protection, LSP. Both the primary and secondary LSPs share ingress and egress LERs, but are preferably routed along different LSRs. LSPs can be established statically by configuration of management layers, or dynamically by signaling protocols.

FIG. 1 depicts a representative although greatly simplified MPLS topology. The MPLS topology includes a set of Customer Edge (CE) nodes CE1 and CE2, Label Edge Routers LER1 and LER2 and Label Switched Routers LSR1 and LSR2. At each LER, the traffic from CE nodes will be encapsulated with MPLS labels and transmitted to the peer LER over LSPs. The LSP is configured with linear protection, with a primary LSP traversing through LER1->LSR1->LER2, and secondary LSP traversing through LER1->LSR2->LER2 (similar redundant paths may be defined in the reverse direction).

The Transport Profile of Multiprotocol Label Switching (MPLS-TP) is a packet-based transport technology based on the MPLS data plane, which re-uses many aspects of the MPLS management and control planes. LSP is also used by MPLS-TP as transport path for data forwarding.

In an MPLS-TP network, survivability is critical for the delivery of guaranteed network services, such as those subject to strict Service Level Agreements (SLAB) which place maximum bounds on the length of time that services may be degraded or be unavailable. Survivability refers to the ability of the network to recover traffic within a certain time in case of failure of the transport path that is used to deliver service. Normally, the required recovery time is less than 50 milliseconds. The failure of a LSP can be caused by the failure of a link or node, or a partial node failure (e.g., one or more line cards in a node, such as an LER). When linear protection is employed by configuring primary and secondary LSPs between the same LERs, if an LER includes multiple line cards, it is preferred to originate/terminate the secondary LSP on a different line card than the primary LSP, to achieve higher survivability in case there is a failure or scheduled maintenance on a line card. When there is a link failure, all the primary LSPs transmitted through the link must be switched over to their corresponding secondary LSPs. A line card failure can be processed as multiple link failures, i.e., all of the primary LSP transmitted through each link on the line card must be switched over to their corresponding secondary LSPs.

The switchover to the secondary LSP is normally done by setting a failover object in the forwarding chip. A unique failover object is associated with each LSP. The failover object is normally linked to the forwarding entry of the LSP on the ingress side. When an incoming data packet is received on the ingress side of the LSP, the forwarding entry is located by looking up the Forwarding Equivalence Class (FEC). Included in the forwarding entry is an index to the failover object. Each time a packet needs to be forwarded with the forwarding entry, its corresponding failover object will be checked to see if switchover to the secondary path is activated. If not, the packets are forwarded using the forwarding entry. If switchover is activated, the packets will be forwarded using, a different next forward entry, e.g., the next forwarding entry (i.e., the forwarding entry is incremented), which corresponds to the secondary LSP.

When there is link failure or card failure, iterating over all the LSPs over all the failed links, and setting their failover objects in the forwarding chip, could involve iterations of complex control software processing and inter-card communications. This could be time consuming, and could place the 50 millisecond switchover limitation at risk.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure, and is not intended to identify key/critical elements of embodiments of the invention or delineate the scope of the invention. The sole purpose of this summary is to present some concepts disclosed herein in a simplified form as a prelude to the more detailed description that is presented later.

One or more embodiments described and claimed herein provide an improved method and apparatus for performing fast traffic switchover based on server layer status. To do fast traffic switchover when there is server layer failure, each forwarding entry contains an index to server layer status table, wherein traffic is associated to a service layer based on the physical communication resources used by the primary path. The server layer status table contains status code for all instances of server layers in the system. One status code indicates the server layer status is normal, and primary paths may be used to carry client layer traffic. Another status code indicates abnormal condition on the server layer, and that primary paths cannot be used to carry client layer traffic. When the forwarding entry is used to forward incoming packets, the server layer status code is checked. If the status code indicates normal functionality, the failover object is checked to route the traffic along either the primary or secondary path. If the status code indicates the server layer is non-functional, the forwarding entry corresponding to the secondary path is used to forward incoming packets. When a failure is detected, or a known failure is cured, the server layer status table is updated.

In one embodiment of the present invention, the traffic switchover methodology is implemented in an MPLS or MPLS-TP network utilizing LSP linear protection. In this embodiment, all the primary LSPs over a link can be rapidly switched over to their corresponding secondary LSPs by simply setting the server layer status table for the failed link. The control software does not need to iterate over all the LSPs and set their failover objects in the forwarding chip.

One embodiment relates to a method, performed by a node operative in a data communication network, of rapidly forwarding data packets along one of redundant paths. A data packet, to be forwarded on a primary or secondary path to a destination, is received. The data packet is classified into a server layer defined by the physical facilities utilized by the primary path. A forwarding table index is derived from the received data packet. A forwarding table is indexed using the forwarding table index and a server layer index is obtained from a forwarding table entry. A server layer status table is indexed using the server layer index to determine whether the primary path associated with the server layer is functional. If the primary path is not functional, the data packet is forwarded along the secondary path toward the destination.

Another embodiment relates to a node operative in a data communication network. The node is operative to forward packets along one of redundant paths toward a destination. The node includes a plurality of line cards. Each line card includes a processor, memory operative to store a forwarding table and a server layer table, and a forwarding chip. The node also includes a control board. A processor on the control board is operative to exchange control and management messages with each line card processor. A switching fabric on the control board is operative to direct data packets between each line card forwarding chip. A received data packet is classified into a server layer defined by the physical facilities comprising primary and secondary paths toward the packet's destination. A line card processor receiving a data packet is operative to derive a forwarding table index from the received data packet; index a forwarding table stored in memory using the forwarding table index to obtain a server layer index from a forwarding table entry; index a server layer status table using the server layer index to determine whether the primary path associated with the server layer is functional; and if the primary path is not functional, forward the data packet along the secondary path toward the destination.

### BRIEF DESCRIPTION OF THE DRAWINGS

FIG. 1 is a block diagram of a conventional MPLS communication network topology.

FIG. 2 is a functional block diagram of a Label Edge Router.

FIG. 3 is a diagram of a forwarding table entry.

FIG. 4 is a diagram of a server layer table.

FIG. 5 is a diagram of a redundancy table.

FIG. 6 is a flow diagram of a method of transmitting packets on redundant paths.

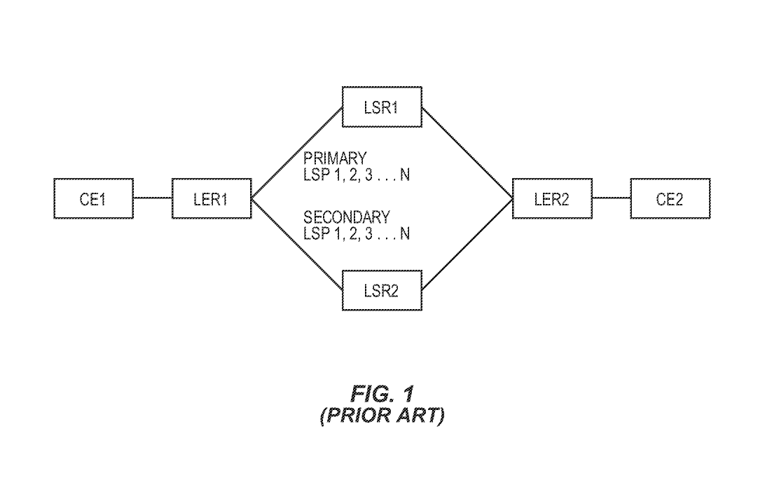

### DETAILED DESCRIPTION

Embodiments of the present invention include a method and apparatus for performing switchover from primary to secondary paths based on server layer status. In one embodiment, all primary LSPs configured over a failed link can be fast switched over to their corresponding secondary LSPs by simply setting a server layer status table entry associated with the failed link. The control software does not have to iterate over all the LSPs and individually set their failover objects in the forwarding chip. It should be noted that PseudoWire (PW) could also be used instead of LSPs.

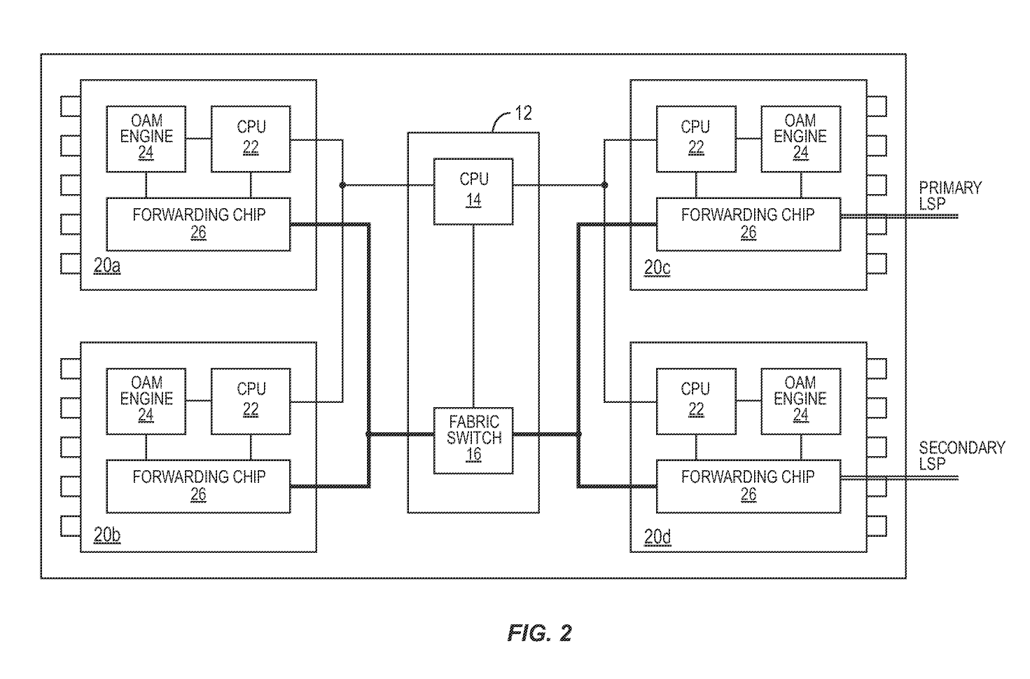

FIG. 2 depicts a communication network node 10, with may for example be configured as a LER for transmitting data packets on redundancy LSPs. The node 10 includes one control board 12 and four line cards 20a-20d. The control board includes a CPU 14 and switching fabric 16. Each of the line cards 20a-20d includes a CPU 22, an OAM engine 24, and a forwarding chip 26. The control board CPU 14 is operative to communicate with the line card CPUs 22; they can exchange control and management messages. The forwarding chips 26 are connected to the switching fabric 16 on the control board 12. The switching fabric 16 receives packets from, and forwards packets to, forwarding chips 26 on the line cards 20a-20d.

A plurality of primary LSPs (LSP 1, 2, 3, . . . , N) is configured on line card 20c, and N corresponding secondary LSPs are configured on line card 20d. Each secondary LSP n is used as a 1:1 linear protection path for the corresponding primary LSP n. The attachment circuits of the LSPs are configured at line cards 20a and 20b. At the line cards 20a and 20b where attachment circuit is connected, a forwarding entry—that is, an entry in a forwarding table maintained by the forwarding chip 26—for the traffic from the attachment circuit is determined based on Forwarding Equivalence Class. For example, it could be an IPv4 prefix for IPv4 traffic, port plush VLAN for layer2 Ethernet traffics, and the like.

In the forwarding table, there is one forwarding entry for each primary LSP. In one embodiment, the forwarding entry next to the forwarding entry of primary LSP is reserved for its secondary LSP if linear protection is configured for the primary LSP that is, the forwarding table index for a primary LSP is simply incremented to index the forwarding entry of its associated secondary LSP. Of course, other offsets or indexing schemes may be utilized.

In the prior art, when a failure is detected on the primary LSP by OAM (for example, the Bidirectional Forwarding Detection protocol), one failover object associated with the forwarding entry of the primary LSP will be set, and then the forwarding entry of the secondary LSP is used to forward all traffic destined to the primary LSP; hence the traffic is re-routed to the secondary LSP. When a failure is detected on a link where multiple primary LSPs are configured, traffic destined to all the impacted primary LSPs must be re-routed to the corresponding secondary LSPs. In the prior art, this requires that all the failover objects associated with all the primary LSPs must be set, to re-route the traffic to all the corresponding secondary LSPs.

According to one embodiment of the present invention, when a failure is detected on a link where one or more primary LSPs are configured, only a link status table entry needs to be updated to allow traffic destined to the impacted primary LSPs to re-route to their corresponding secondary LSPs. It is not required to set all the failover objects associated with all impacted primary LSPs. The switchover of many primary LSPs to their corresponding secondary LSPs is faster and requires less control software processing.

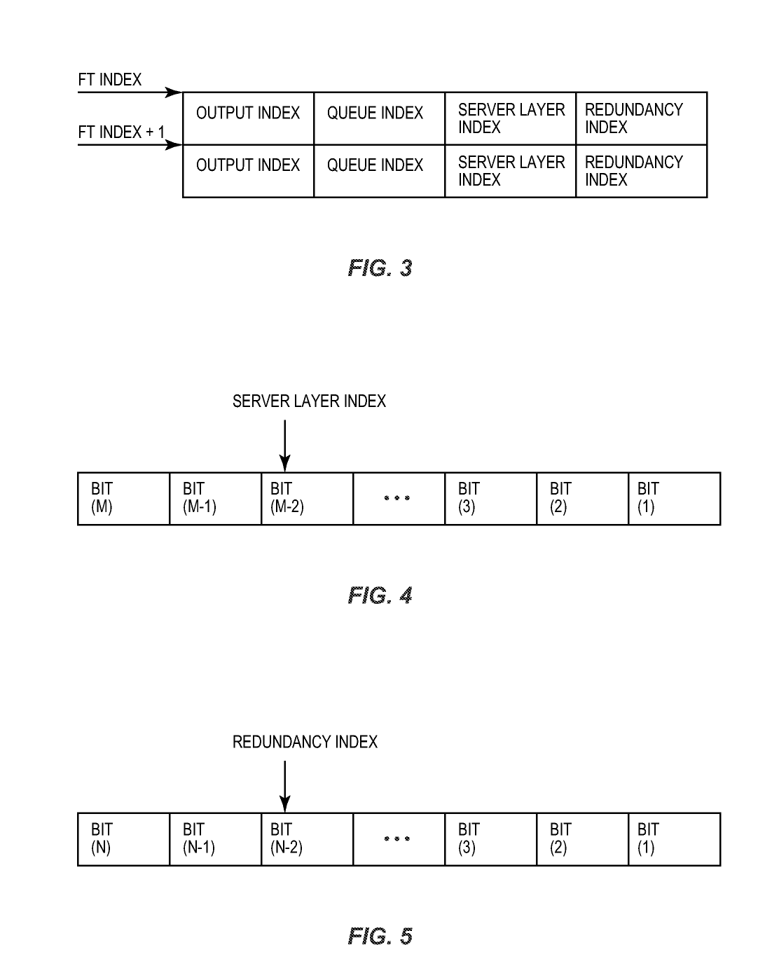

FIG. 3 depicts two entries in one embodiment of the forwarding table. The forwarding table is indexed by a forwarding index derived from a received data packet (in this embodiment, the forwarding index for a secondary LSP is the forwarding index of the primary LSP incremented by one). Each forwarding table entry includes the following fields: OUTPUT INDEX, QUEUE INDEX, SERVER LAYER INDEX and REDUNDANCY INDEX. The OUTPUT INDEX is used by the egress forwarding chip 26 to locate egress encapsulation information. The QUEUE INDEX is used by the switching fabric 16 to determine the forwarding chip 26 to which the packet should be switched. The SERVER LAYER INDEX is an index into a server layer status table, used to obtain the status of the primary path. The REDUNDANCY INDEX is an index into a redundancy table, used to obtain the status of the secondary (redundancy) path. The forwarding table is configured by control software. The configuration information may be obtained from the management plane or control plane.

FIG. 4 is a diagram illustrating the server layer status table used to store status of the server layer according to one embodiment of this invention. The server layer status table is indexed with the SERVER LAYER INDEX stored in the Forwarding table. The server layer status table is basically a bitmap. Each bit represents an entry which can be used to store the status of the server layer. If the bit is 0, it means the server layer is normal to do forwarding. When there is a failure detected on the server layer, the corresponding entry in the server layer status table will be set to 1. The detection of the server layer failure could be achieved by different mechanism, such link status scan on the physical layer chip of the link, or Link level OAM, etc. The mechanism to detect the server layer failure could be implemented by software or hardware or FPGA. Accordingly, updating of the server layer status table could be initiated by software or hardware or FPGA

FIG. 4 depicts one embodiment of the server layer status table used to store the status of each server layer. A server layer is defined in terms of the physical communications resources utilized by one or more primary paths. For example, with reference to FIG. 2, primary LSPs 1, 2, 3, . . . , N are all configured into the same server layer, as they all utilize the same resources (namely, line card 20c, and additionally the network link exiting the LER 10). In this embodiment, the server layer status table is a bit array indexed by the SERVER LAYER INDEX obtained from the forwarding table. For example, bit N in the server layer status table corresponds to the SERVER LAYER INDEX N. In normal conditions, when the primary paths are functional, bit N is set to 0. When a failure is detected in the server layer, affecting one or more primary paths, the bit N will be set to 1, indicating that the primary path is unable to forward traffic; in this case, traffic is automatically routed to along the secondary path. The detection of failure on the server layer could be achieved by different mechanism, such link status scan on the physical layer chip of the link, link level OAM, and the like. The mechanism to detect the server layer failure could be implemented by software, hardware, or FPGA. Accordingly, updating of the server layer status table could be initiated by software, hardware, or FPGA.

FIG. 5 depicts one embodiment of the redundancy table used to store redundancy status of the linearly protected primary paths. In this embodiment, the redundancy table is a bit array indexed by the REDUNDANCY INDEX obtained from the forwarding table. For example, bit N in the redundancy table corresponds to the REDUNDANCY INDEX N. In normal conditions, bit N is set to 0, indicating that a secondary path is inactive. If it is determined by linear protection logic that a switchover from the primary to a secondary LSP should be triggered, the bit N will be set to 1. When it is determined by the linear protection logic that the traffic should be restored from secondary LSP to the primary LSP, the bit N will be reset to 0. The linear protection logic could be implemented in software, or hardware, or FPGA. Accordingly, the update of the redundancy table could also be initiated by software, hardware, or FPGA.

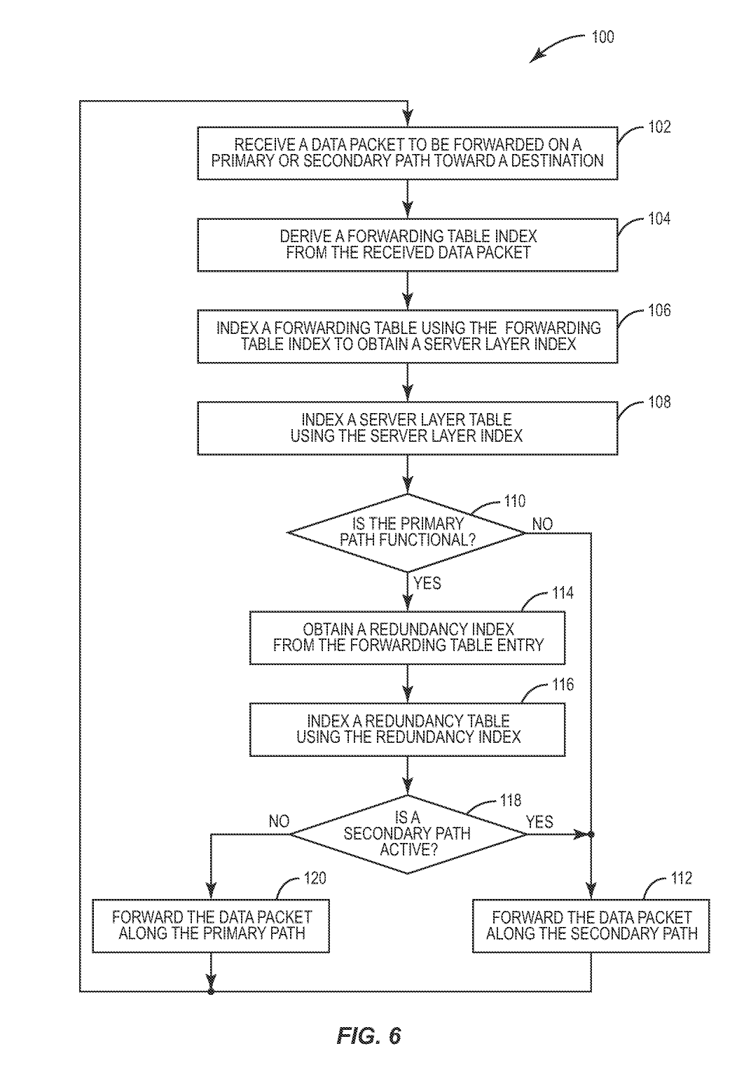

FIG. 6 depicts a method 100 of rapidly forwarding data packets along one of redundant paths. A data packet is received (block 102), the data packet to be forwarded on a primary or secondary path to a destination, and the data packet classified into a server layer defined by the physical facilities utilized by the primary path. A forwarding table index is obtained from the data packet (block 104). The forwarding table index may be obtained, e.g., by indexing a Forwarding Equivalence Class table using information obtained from the data packet, such as an IP address. A forwarding table entry, or forwarding entry, is obtained from the forwarding table. The forwarding entry includes a SERVER LAYER INDEX (block 106). A server layer status table is indexed using the SERVER LAYER INDEX (block 108) to obtain an indication of whether the primary path(s) in the server layer are functional. If the primary path is not functional (block 110) the data packet is forwarded towards the destination along the secondary path (block 112).

If the server layer table entry indicates that the primary path is functional, a REDUNDANCY INDEX is obtained from the forwarding entry (block 114). A redundancy table is indexed using the REDUNDANCY INDEX (block 116) to obtain an indication of whether a secondary path has been configured for the primary path, and is active. If a secondary path is active (block 118), then the data packet is forwarded towards the destination along the secondary path (block 112). If the secondary path is not active (block 118), the data packet is forwarded towards the destination along the primary path (block 120).

In either case (primary or secondary path), the data packet is forwarded towards its destination by adding the OUTPUT INDEX obtained from the forwarding entry to the data packet, and directing the packet through the switching fabric 16 using the QUEUE INDEX also obtained from the forwarding entry. If the data packet is to be routed along the primary path, these pointers are obtained from the forwarding entry obtained using the forwarding index derived from the data packet. In one embodiment, if the data packet is to be routed along the secondary path, the OUTPUT INDEX and QUEUE INDEX are obtained from the next forwarding entry. That is, the forwarding table index is incremented by one. In this embodiment, every e.g. odd forwarding entry is associated with a server layer (i.e., one or more primary paths), and every even entry is associated with the secondary paths configured for the immediately preceding primary paths. Of course, other offsets or other organizations of the forwarding table may be used.

The switching fabric 16 routes the data packet to the forwarding chip 26 on the line card 20a-20d on which the selected (primary or secondary) path is configured, based on the QUEUE INDEX from the appropriate forwarding entry. The forwarding chip 26 indexes an encapsulation table using the OUTPUT INDEX, to obtain parameters necessary to encapsulate the data packet for launch into the network, such as source and destination MAC addresses, LSP labels, and the like. The data packet is then forwarded to another node in the network.

Embodiments of the present invention present numerous advantages over packet routing and transmission according to the prior art. For example, system response in the face of a detected failure is improved by avoiding the need to iterate through all LSPs to set the failover object. Additionally, system software complexity is reduced, improving robustness, since one or two table entries need to be changed for each server layer when a failure is detected (or removed).

Although described herein with reference to the MPLS and MPLS-TP protocols, the present invention is not so limited, and is in fact applicable in any network node where data packets are transmitted on redundant paths.

The CPUs 14, 22 may comprise any sequential state machine operative to execute machine instructions stored as machine-readable computer programs in memory, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

The forwarding table, server layer status table, redundancy table, and encapsulation tables are preferably implemented in machine-readable memory. Those of skill in the art also readily recognize that memory is necessary for operation of the CPUs 14, 22. Such memory may comprise any non-transient machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, etc.), or the like.

Although the server layer status table and redundancy table are described herein as comprising bit arrays, with particular meaning assigned to bit values, those of skill in the art will readily recognize that these embodiments are illustrative only, and not limiting. For example, the opposite meanings than those described could be assigned to the bit values 1 and 0. Furthermore, these lookup table entries may comprise more information than a single bit, with additional functionality or information associated with the table entry values.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method, by a node operative in a data communication network, of rapidly forwarding data packets along one of redundant paths, comprising:
receiving a data packet to be forwarded on a primary or secondary path to a destination, the data packet classified into a server layer defined by physical facilities utilized by the primary path;
deriving a forwarding table index from the received data packet;
indexing a forwarding table using the forwarding table index and obtaining a server layer index from a forwarding table entry;
indexing a server layer status table using the server layer index to determine whether the primary path associated with the server layer is functional; and
if the primary path is not functional, forwarding the data packet along the secondary path toward the destination.

2. The method of claim 1, wherein the server layer status table comprises a bit array, and wherein determining whether the primary path associated with the server layer is functional comprises retrieving an entry from the server layer status table indicative of a functional primary path.

3. The method of claim 1, further comprising:
obtaining a redundancy index from the forwarding table entry;
indexing a redundancy table using the redundancy index to determine whether a secondary path is active;
if the secondary path is active, forwarding the data packet along the secondary path toward the destination; and
if the primary path is functional and the secondary path is inactive, forwarding the data packet along the primary path toward the destination.

4. The method of claim 3, further comprising:
obtaining a queue index and an output index from the forwarding table entry;
and wherein forwarding the data packet along the primary path toward the destination comprises
forwarding the data packet to a forwarding chip on the node in response to the queue index; and
at the forwarding chip, encapsulating the data packet with parameters retrieved using the output index.

5. The method of claim 4, wherein forwarding the data packet along the secondary path toward the destination comprises:
adding a predetermined offset to the forwarding table index to obtain a secondary path forwarding table index; and
indexing the forwarding table using the secondary path forwarding table index to obtain a queue index and an output index for the secondary path.

6. The method of claim 5, wherein forwarding the data packet along the secondary path toward the destination further comprises:
forwarding the data packet to a forwarding chip on the node in response to the queue index for the secondary path; and
at the forwarding chip, encapsulating the data packet with parameters retrieved using the output index for the secondary path.

7. The method of claim 1, further comprising:
detecting a failure of one or more communication resources on the node; and
in response to the failure detection, for each server layer for which a primary path uses a failed communication resource, setting a server layer status table bit to a value indicating the primary path is non-functional.

8. The method of claim 7, further comprising, for each secondary path not affected by a failure of communication resources, setting bits in the redundancy table to indicate associated secondary paths are active.

9. The method of claim 1, wherein the primary and secondary paths are Label Switched Path, LSP, or PseudoWire of a Multi-Protocol Label Switching, MPLS, protocol.

10. A node operative in a data communication network, and further operative to forward packets along one of redundant paths toward a destination, the node comprising:
a plurality of line cards, each line card including a processor, memory operative to store a forwarding table and a server layer table, and a forwarding chip; and
a control board including a processor operative to exchange control and management messages with each line card processor and a switching fabric operative to direct data packets between each line card forwarding chip;
wherein the processor on a line card receiving a data packet, the data packet classified into a server layer defined by physical facilities comprising primary and secondary paths toward a destination, is operative to
derive a forwarding table index from the received data packet;
index a forwarding table stored in memory using the forwarding table index to obtain a server layer index from a forwarding table entry;
index a server layer status table using the server layer index to determine whether the primary path associated with the server layer is functional; and
if the primary path is not functional, forward the data packet along the secondary path toward the destination.

11. The node of claim 10, wherein the server layer status table comprises a bit array, and wherein the receiving line card processor is operative to determine whether the primary path associated with the server layer is functional by retrieving an entry from the server layer status table indicative of a functional primary path.

12. The node of claim 10, wherein the memory is further operative to store a redundancy table and wherein the receiving line card processor is further operative to
obtain a redundancy index from the forwarding table entry;
index a redundancy table using the redundancy index to determine whether a secondary path is active;
if the secondary path is active, forward the data packet along the secondary path toward the destination; and
if the primary path is functional and the secondary path is inactive, forward the data packet along the primary path toward the destination.

13. The node of claim 12, wherein the receiving line card processor is further operative to
obtain a queue index and an output index from the forwarding table entry;
and wherein the processor is operative to forward the data packet along the primary path toward the destination by forwarding the data packet to a forwarding chip on another line card in response to the queue index.

14. The node of claim 13, wherein the receiving line card processor is operative to forward the data packet to a forwarding chip on an egress line card by sending the data packet to the switching fabric on the control board.

15. The node of claim 13, wherein the receiving line card processor is operative to forward the data packet along the secondary path toward the destination by
adding a predetermined offset to the forwarding table index to obtain a secondary path forwarding table index;
indexing the forwarding table using the secondary path forwarding table index to obtain a queue index for the secondary path; and
forwarding the data packet to a forwarding chip on an egress line card in response to the queue index for the secondary path.

16. The node of claim 15, wherein a forwarding chip on the egress line card for the primary or secondary path is operative to encapsulate the data packet with parameters retrieved using the output index for the primary or secondary path, respectively.

17. The node of claim 10, wherein the processor on the control board is operative to
detect a failure of one or more communication resources on the node; and
in response to the failure detection, for with each server layer for which a primary path uses a failed communication resource, set an server layer status table entry to a value indicating the primary path is non-functional.

18. The node of claim 17, wherein the control board processor is further operative to, for each secondary path not affected by a failure of communication resources, set entries in the redundancy table to indicate associated secondary paths are active.

19. The node of claim 10, wherein the primary and secondary paths are Label Switched Path, LSP, or PseudoWire of a Multi-Protocol Label Switching, MPLS, protocol.
